(19) United States
(12) Patent Application Publication
(10) Pub. No.: US 2023/0081084 A1
(43) Pub. Date: Mar. 16, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Kouichi ODAJIMA, Kanagawa (JP)

(73) Assignee: FUJIFILM Business Innovation Corp., Tokyo (JP)

(21) Appl. No.: 17/705,360

(22) Filed: Mar. 27, 2022

(30) Foreign Application Priority Data
Sep. 15, 2021 (JP) 2021-150010

(51) Int. Cl. G06Q 10/06; G07C 9/32

(52) U.S. Cl. CPC G06Q 10/063114; G07C 9/32

(57) ABSTRACT

An information processing apparatus includes a processor configured to generate, in a case where a device with which the information processing apparatus does not begin to communicate is to be installed in a user's facility, a registration code to be used to register information regarding the device, notify an installation person of installation information regarding installation of the device while attaching the registration code to the installation information, the installation information including at least user identification information for identifying the user, and register, if a registration code that has been input by the installation person using the device installed in the user's facility and that has been transmitted along with identification information regarding the device matches the registration code generated for the device, the identification information regarding the device and the user identification information for identifying the user to a memory for managing devices while associating the identification information regarding the device and the user identification information for identifying the user with each other.

### CROSS-REFERENCE TO RELATED APPLICATIONS

This application is based on and claims priority under 35 USC 119 from Japanese Patent Application No. 2021-150010 filed Sep. 15, 2021.

### BACKGROUND

### (i) Technical Field

The present disclosure relates to an information processing apparatus, a non-transitory computer readable medium, and an information processing method.

### (ii) Related Art

Companies that sell devices and provide services relating to the devices, for example, usually manage information while associating devices installed at customers' sites and users for whom the devices are installed with each other.

There is conventionally a method for asking a customer to input authentication information regarding the customer in order to associate the customer and sold devices with each other appropriately. When a device installed at a customer's site is a multifunction printer (MFP), for example, a company that sells the MFP registers information regarding a user, who is the customer, to a database and transmits a mail for setup to the customer. A manager or the like at the customer's site sets authentication information for initial settings including a user identifier (ID) and a password in accordance with an instruction described in the mail and registers the authentication information to the company in advance. After the MFP is delivered, the manager displays a setup screen on an operation panel of the MFP by performing a certain operation and inputs, on the setup screen, the authentication information for initial settings set in advance.

The MFP transmits the input authentication information to the company while attaching identification information for identifying the MFP to the authentication information in accordance with an input operation performed by the manager.

If the user is successfully authenticated on the basis of the authentication information transmitted from the MFP, the company associates the information regarding the user and the identification information regarding the MFP. As a result, the MFP becomes available to the user (examples of the related art include Japanese Patent No. 6687641 and Japanese Unexamined Patent Application Publication No. 2006-014325).

### SUMMARY

When it is possible to begin to communicate with a device installed at a user's site, identification information regarding the device can be obtained by accessing the device after the device is installed. A user and a device installed at the user's facility, therefore, can be associated with each other without bothering the user.

When it is difficult to begin to communicate with a device installed at a user's site, however, the user is conventionally asked to register authentication information for setup in advance and, after the installation, input the authentication information using the device in order to associate the user and the device with each other.

Aspects of non-limiting embodiments of the present disclosure relate to registration of information without asking a user to input authentication information when it is difficult for an information processing apparatus to begin to communicate with a device owned by the user and information needs to be registered while associating the device newly installed in the user's facility and the user with each other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: generate, in a case where a device with which the information processing apparatus does not begin to communicate is to be installed in a user's facility, a registration code to be used to register information regarding the device; notify an installation person of installation information regarding installation of the device while attaching the registration code to the installation information, the installation information including at least user identification information for identifying the user; and register, if a registration code that has been input by the installation person using the device installed in the user's facility and that has been transmitted along with identification information regarding the device matches the registration code generated for the device, the identification information regarding the device and the user identification information for identifying the user to a memory for managing devices while associating the identification information regarding the device and the user identification information for identifying the user with each other.

### BRIEF DESCRIPTION OF THE DRAWINGS

An exemplary embodiment of the present disclosure will be described in detail based on the following figures, wherein:

FIG. 1 is a block diagram illustrating the configuration of a device management system according to the exemplary embodiment;

FIG. 2A is a sequence diagram illustrating a process for registering information while associating a customer and an MFP with each other according to the exemplary embodiment;

FIG. 2B is a sequence diagram following that of FIG. 2A;

FIG. 3A to 3C are diagrams illustrating an example of the data configuration of sales information according to the exemplary embodiment;

FIGS. 4A to 4D are diagrams illustrating an example of the data configuration of various pieces of information registered to a master database according to the exemplary embodiment;

FIG. 5A is a diagram illustrating an example of a user registration screen according to the exemplary embodiment;

FIG. 5B is a diagram illustrating an example of a screen displayed after the user registration screen illustrated in FIG. 5A in accordance with an operation performed by a delivery person;

FIG. 5C is a diagram illustrating an example of a screen displayed after that illustrated in FIG. 5B;

FIG. 5D is a diagram illustrating an example of a screen displayed after that illustrated in FIG. 5C; and

FIGS. 6A to 6D are diagrams illustrating the data configuration of various pieces of information after a customer and an MFP are associated with each other in the various pieces of information in the master database illustrated in FIGS. 4A to 4D.

### DETAILED DESCRIPTION

An exemplary embodiment of the present disclosure will be described hereinafter with reference to the drawings.

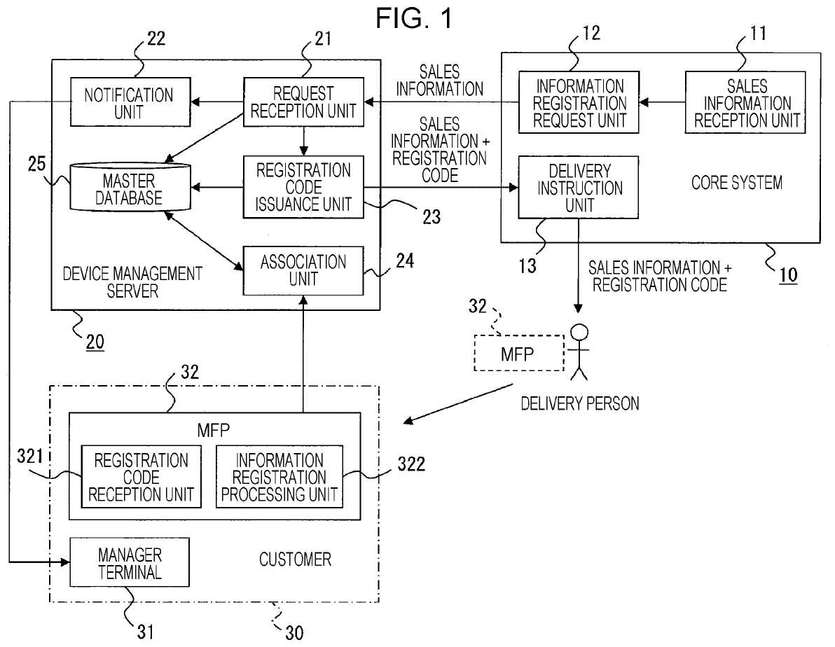

FIG. 1 is a block diagram illustrating the configuration of a device management system according to the present exemplary embodiment. FIG. 1 illustrates a core system 10 and a device management server 20, which together achieve the device management system, and a customer 30, for which devices managed by the device management system are to be installed. In the present exemplary embodiment, an example will be described where the device management system is applied to a company whose salesperson sells MFPs 32, which are an example of the devices, to the customer 30 and whose delivery person who doubles as an installation person delivers the MFPs 32 to a facility of the customer 30 and installs the MFPs 32 in the facility. In the present exemplary embodiment, therefore, “devices” and “MFPs” are synonymous. There are plural customers 30 to which MFPs 32 are to be sold in practice, but FIG. 1 illustrates only one customer 30 because the same process may be performed for every customer 30.

The core system 10 forms a core of the device management system and is achieved by one or plural computers. The core system 10 is installed in an office of the company that sells the MFPs 32 and that provides services relating to the MFPs 32.

The computer(s) that achieves the core system 10 according to the present exemplary embodiment can be achieved by a conventional general-purpose hardware configuration. That is, the core system 10 is achieved by a central processing unit (CPU), storage means such as a read-only memory (ROM), a random-access memory (RAM), or a hard disk drive (HDD), a user interface including, for example, a mouse, keyboard, and a display, a network interface, and the like.

The core system 10 according to the present exemplary embodiment includes a sales information reception unit 11, an information registration request unit 12, and a delivery instruction unit 13. The sales information reception unit 11 receives sales information including, for example, information regarding devices sold by a salesperson and a customer 30 to which the devices have been sold. The information registration request unit 12 requests the device management server 20 to register sales information received by the sales information reception unit 11, that is, manage information regarding sold MFPs 32. The delivery instruction unit 13 instructs a delivery person to deliver sold MFPs 32.

The sales information reception unit 11, the information registration request unit 12, and the delivery instruction unit 13 of the core system 10 are achieved when the computer(s) that achieves the core system 10 executes a program that operates on the CPU of the computer(s).

The device management server 20 is a computer for managing information regarding sold devices. It is assumed in the present exemplary embodiment that the device management server 20 is provided separately from the core system 10 as a cloud server in consideration of security and convenience of communication with the customer 30. It is needless to say that the device management server 20 may be provided in the same office as the core system 10, or the device management server 20 may be integrated with the core system 10, instead.

The device management server 20 according to the present exemplary embodiment is achieved by the hardware configuration of a conventional general-purpose server computer. That is, the device management server 20 is achieved by a CPU, storage means such as a ROM, a RAM, or an HDD, a network interface, and the like. A user interface may be provided as necessary.

The device management server 20 includes a request reception unit 21, a notification unit 22, a registration code issuance unit 23, an association unit 24, and a master database 25. FIG. 1 does not illustrate components that are not used to describe the present exemplary embodiment.

The request reception unit 21 registers sales information transmitted from the core system 10 in accordance with a request to register the sales information. After the request reception unit 21 registers the sales information to the master database 25, the notification unit 22 transmits, to a customer 30 that has purchased MFPs 32, a service start notification indicating that services of the MFPs 32 will become available from a specified date once the MFPs 32 are set up. After the request reception unit 21 registers the sales information to the master database 25, the registration code issuance unit 23 issues a registration code for registering information regarding the MFPs 32 installed for the customer 30 while associating the registration code with the customer 30 that has purchased the MFPs 32. “Issuance” herein is synonymous with “generation”. The association unit 24 receives the registration code transmitted from the customer 30 and, if the received registration code is correct, registers device IDs of the MFP 32 transmitted from the customer 30 along with the registration code to the master database 25 while associating the device IDs with information for identifying the customer 30.

The master database 25 is storage means for managing sold MFPs 32 and saves various pieces of information on the basis of sales information. Items and a data configuration of the information saved in the master database 25 will be described later along with processing.

The request reception unit 21, the notification unit 22, the registration code issuance unit 23, and the association unit 24 of the device management server 20 are achieved when a computer that achieves the device management server 20 executes a program that operates on the CPU of the computer. The master database 25 is achieved by the HDD of the device management server 20. Alternatively, the RAM may be used, or external storage means may be used over a network.

A manager terminal 31 and an MFP 32 are installed in the facility of the customer 30. The manager terminal 31 is a terminal apparatus used by a manager of the MFP 32 at a company that is the customer 30. The manager terminal 31 is achieved by a conventional personal computer (PC) or the like. The delivery person of the company that sells the MFP 32 delivers the MFP 32 purchased by the customer 30 to the facility of the customer 30 and installs the MFP 32 in the facility.

The MFP 32 is an example of an image forming apparatus having various functions such as a printing function, a copying function, and a scanning function and includes a computer therein. That is, the MFP 32 includes a CPU, a ROM, a RAM, an HDD, an operation panel, a network interface, and/or the like. The MFP 32 also includes a scanner and a printer for achieving the various functions. Depending on a model, the MFP 32 also includes a stapler, a finisher, or the like. In the present exemplary embodiment, the functions of the MFP 32 are not particularly limited.

The MFP 32 includes a registration code reception unit 321 and an information registration processing unit 322. FIG. 1 does not illustrate components that are not used to describe the present exemplary embodiment. The registration code reception unit 321 receives a registration code input from the operation panel. The information registration processing unit 322 performs a process for registering, to the device management server 20, information for associating the customer 30 and the MFP 32 with each other.

The registration code reception unit 321 and the information registration processing unit 322 of the MFP 32 are achieved when the computer of the MFP 32 executes a program that operates on the CPU of the computer.

The programs used in the present exemplary embodiment may be provided using communication means or a computer-readable storage medium such as a compact disc read-only memory (CD-ROM) or a universal serial bus (USB) memory. The programs provided using the communication means or the storage medium are installed on the corresponding computers, and the CPUs of the computers execute the programs to achieve various processes.

After the MFP 32 is installed for the customer 30, the device management system according to the present exemplary embodiment obtains identification information (hereinafter referred to as a “device ID”) for identifying the MFP 32 and associates the device ID with identification information regarding the customer 30 in order to manage information regarding the MFP 32 and the customer 30. A model of the MFP 32 delivered to the customer 30 can naturally be identified beforehand from a sales contract, but it is difficult to identify information (corresponds to the device ID) for uniquely identifying the MFP 32, such as a serial number, until the MFP 32 is delivered to the customer 30 and installed.

As described above, when the device management system can begin to communicate with the MFP 32 installed in the facility of the customer 30, the device management system can obtain a device ID of the MFP 32 by accessing the installed MFP 32. It is therefore possible to associate the customer 30 and the MFP 32 with each other without bothering the manager at the customer 30 or the like.

In some cases, however, it is difficult for the device management system to begin to communicate with the MFP 32 installed in the facility of the customer 30. For example, the device management system might not be able to begin to communicate with a system used by the customer 30 due to a hardware environment, such as a firewall provided at an entrance of a network of the system of the customer 30, or a software environment, such as restrictions imposed by a contract with the customer 30. In such cases, as described above, the customer 30 is asked to register authentication information for setup in advance and, after the MFP 32 is installed, input the authentication information using the operation panel of the MFP 32, in order to associate the customer 30 and the MFP 32 with each other. The MFP 32 transmits the input authentication information to the device management server 20 while attaching the device ID thereof to the authentication information. The device management system thus associates the customer 30 and the MFP 32 with each other after authenticating the customer 30.

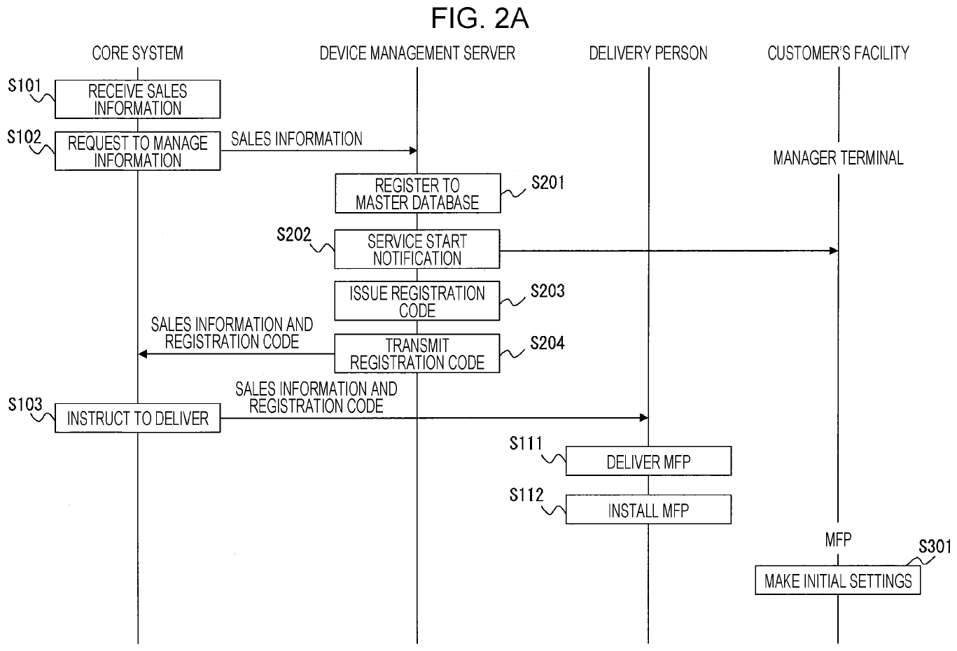

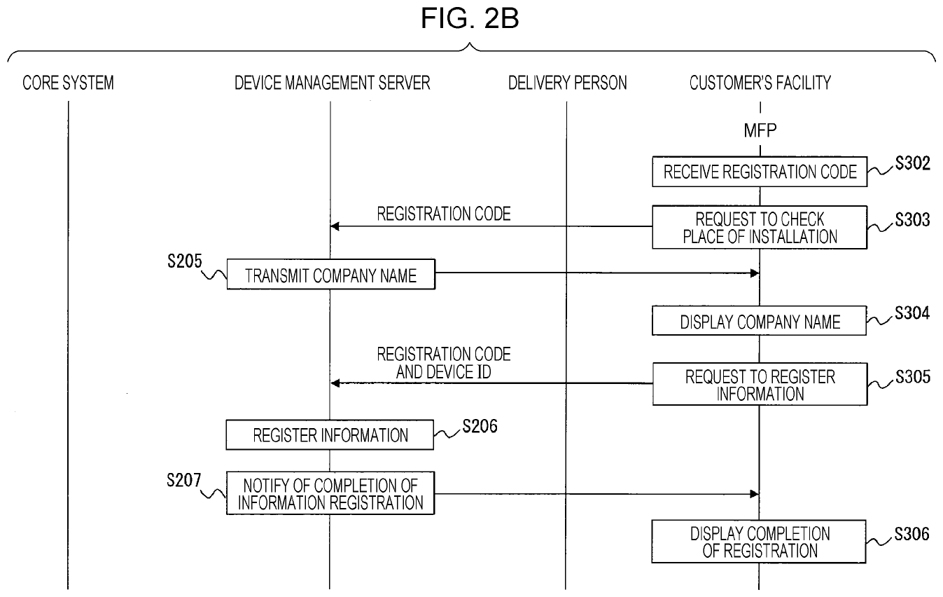

In the present exemplary embodiment, however, even when it is difficult for the device management system to begin to communicate with the MFP 32 installed in the facility of the customer 30, information can be registered while associating the customer 30 and the MFP 32 with each other without bothering the customer 30. A process for registering information while associating a customer 30 and MFPs 32 with each other according to the present exemplary embodiment will be described hereinafter with reference to sequence diagrams of FIGS. 2A and 2B.

A sales person who has sold MFPs 32 inputs sales information including a customer 30 and a contract with the customer 30 to the core system 10 using a PC or the like. The sales information reception unit 11 of the core system 10 receives the input sales information (S101).

Next, the information registration request unit 12 transmits the input sales information to the device management server 20 and requests the device management server 20 to register the sales information to the master database 25 (S102).

In response to the request, the request reception unit 21 of the device management server 20 registers the transmitted sales information to the master database 25

(S201), and transmits a mail, which is a service start notification, to a manager at the customer 30 that has purchased the MFPs 32 (S202). The manager at the customer 30 can check a date of delivery of the MFPs 32, the contract, and the like by receiving the service start notification, but in the present exemplary embodiment, the manager who has received the mail need not take any action to start to use the MFPs 32.

Next, the registration code issuance unit 23 issues a registration code associated with the sales information (S203). The registration code issuance unit 23 then transmits the issued registration code to the core system 10 (S204). Alternatively, the registration code and the sales information may be transmitted together in order to associate the sales information and the registration code with each other.

The data configuration of sales information and various other pieces of information registered to the master database 25 will be described hereinafter.

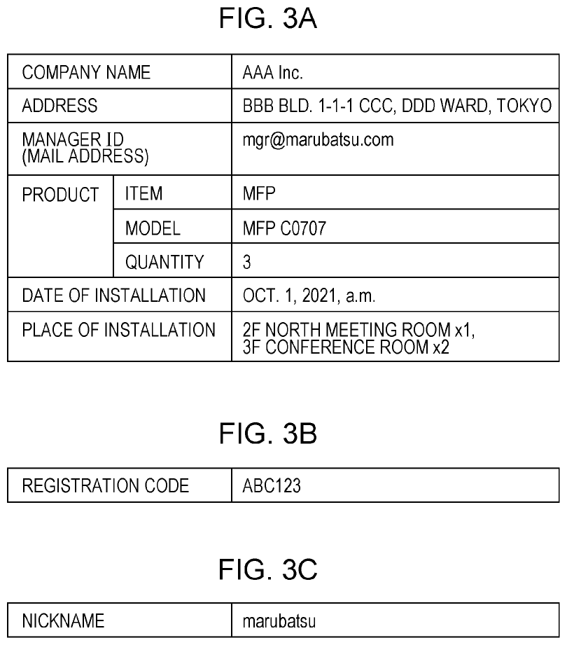

FIGS. 3A to 3C are diagrams illustrating an example of the data configuration of sales information according to the present exemplary embodiment. FIG. 3A illustrates the data configuration of sales information transmitted from the core system 10 to the device management server 20. In the sales information illustrated in FIG. 3A, a company name, an address, and identification information (hereinafter referred to as “manager IDs”) regarding managers of MFPs 32 are set as user identification information for identifying a customer 30 for which the MFPs 32 are installed. In the present exemplary embodiment, a company name is used as user identification information for identifying a customer 30, who is a user of a company that sells MFPs 32. Because mail addresses used by the managers are used as manager IDs in the present exemplary embodiment, the manager IDs are also used as contact information regarding the managers. In the sales information illustrated in FIG. 3A, a sold product, a date of installation of the product, and places of installation are set as a sales contract. The product includes an item, a model, and quantity. Since MFPs 32 are sold in the present exemplary embodiment, the item is “MFP”. Although an example where information regarding only one product is set in the field of “product” in the present exemplary embodiment for convenience of description, information regarding plural products is set when the plural products are sold. A delivery person is notified of sales information in the present exemplary embodiment and uses the sales information as installation information regarding installation of MFPs 32.

FIG. 3B illustrates the registration code. The registration code is information characteristic to the present exemplary embodiment. Sales information transmitted from the device management server 20 to the core system 10, therefore, may include the registration code, instead, although FIGS. 2A and 2B illustrate the registration code separately from sales information. FIG. 3C will be referred to later. The registration code issuance unit 23 generates the registration code by randomly arranging letters and signs.

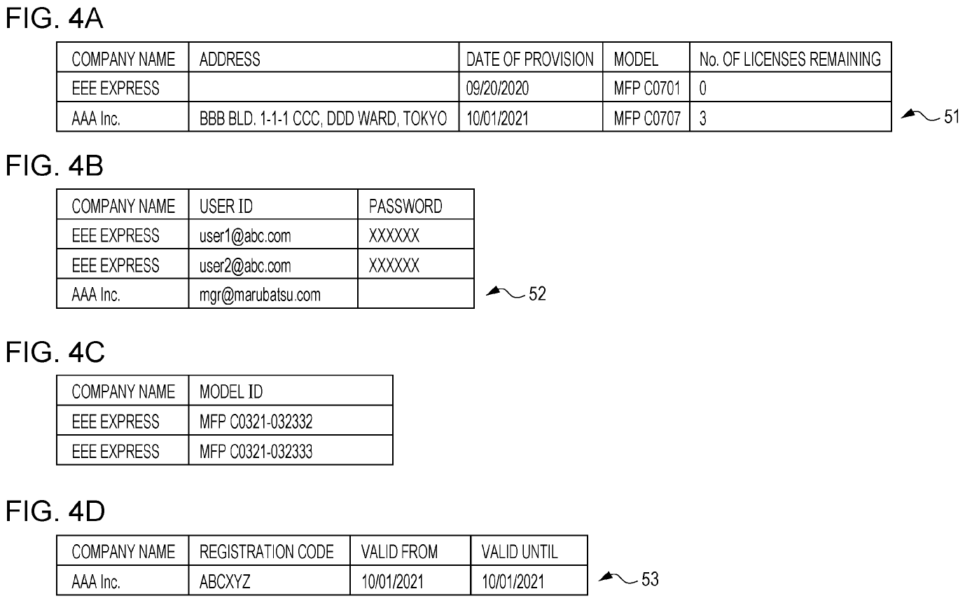

FIGS. 4A to 4D are diagrams illustrating an example of the data configuration of the various pieces of information registered to the master database 25 according to the present exemplary embodiment. The master database 25 according to the present exemplary embodiment manages information while classifying the information into company management information, manager information, device information, and registration code information. The classification of information illustrated in FIGS. 4A to 4D is an example, and another data configuration may be employed, instead. In the present exemplary embodiment, the various pieces of information obtained as a result of the classification based on the company name used as the identification information regarding the customer 30 are associated. The request reception unit 21 registers records 51 to 53 of item data included in sales information to the master database 25 in response to a request from the core system 10.

The company management information is information regarding a company to which MFPs 32 are sold. The company management information includes a company name, an address, a date of provision, a model, and the number of licenses remaining, which are a company name, an address, a date of installation, and a model and a quantity of a product, respectively. In the present exemplary embodiment, the company management information is also used to manage licenses to use MFPs 32, and when an MFP 32 is installed and becomes available, the number of licenses remaining decreases by 1.

The manager information is information regarding the managers at the customer 30. In the manager information, a company name, user IDs, and passwords are set. The user IDs and the passwords are conventional authentication information that is not used in the present exemplary embodiment. A company name and manager IDs included in sales information are set as the company name and the user IDs included in the manager information, respectively. Because the managers manage MFPs 32 on behalf of the customer 30, the manager IDs can be seen as the identification information (i.e., user IDs) regarding the customer 30.

The device information is used to manage sold devices. In the device information, a company name and device IDs of MFPs 32 sold to the customer 30 are set. The customer 30 and the MFPs 32 are associated with each other using the device information.

The registration code information is used to manage a registration code issued by the registration code issuance unit 23. In the registration code information, a company name, a registration code, a beginning of a valid period, and an end of the valid period are set. The beginning of the valid period and the end of the valid period define time information for identifying a valid period of the registration code. A date of installation included in sales information is set as both the beginning of the valid period and the end of the valid period. In the example illustrated in FIG. 4D, the registration code is valid only on a date of installation. If the valid period needs to be longer, that is, if the valid period needs to last for two days or longer, for example, a salesperson may set the beginning of the valid period and the end of the valid period separately in the sales information.

FIG. 2A will be referred to again. Upon receiving the sales information including the registration code from the device management server 20, the delivery instruction unit 13 of the core system 10 transmits the sales information to a terminal apparatus (not illustrated) used by the delivery person. The delivery instruction unit 13 thus instructs the delivery person to deliver the MFPs 32 by notifying the delivery person of details of the delivery (S103).

The delivery person prepares the MFPs 32 of a model included in the sales information in accordance with the delivery instruction and delivers the MFPs 32 to the facility of the customer 30 identified from the address by the date of installation (S111). The delivery person then installs the MFPs 32 at places of installation (S112). Because the delivery person may handle every MFP 32 similarly, installation of only one MFP 32 will be described hereinafter.

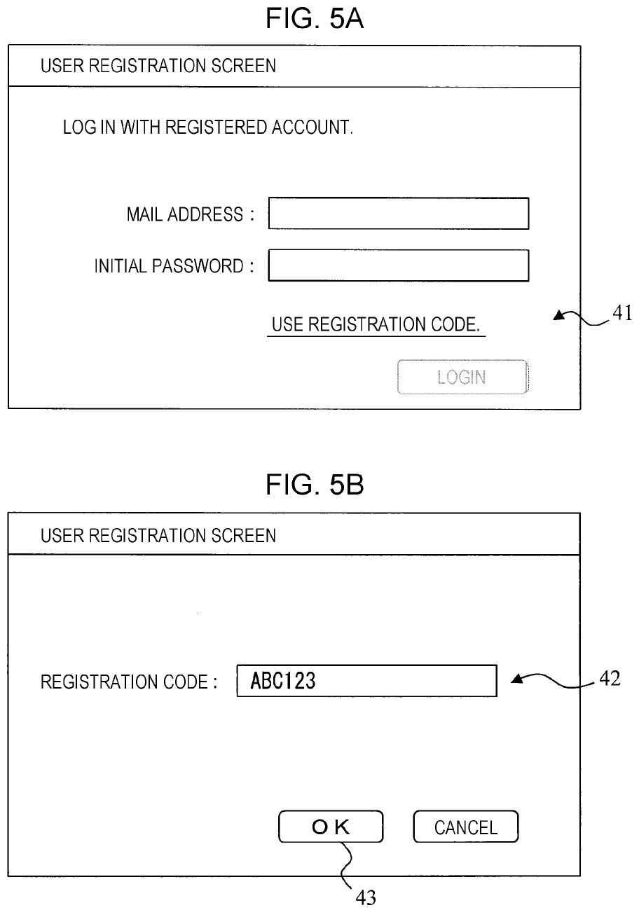

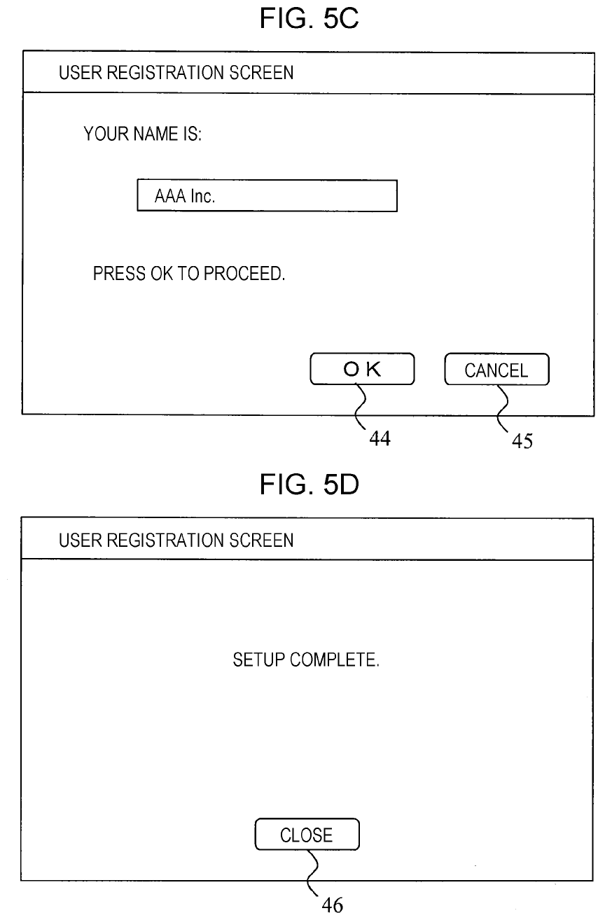

Next, the delivery person makes initial settings for the MFP 32 installed in the facility of the customer 30 in order to make the MFP 32 usable (S301). The delivery person then inputs the registration code using an operation panel. The input of the registration code will be described hereinafter with reference to FIGS. 5A to 5D.

FIGS. 5A to 5D are diagrams illustrating an example of screens displayed on the operation panel of the MFP 32. FIG. 5A illustrates an example of a user registration screen for registering the customer 30 and the MFP 32 to the device management system while associating the customer 30 and the MFP 32 with each other. The user registration screen illustrated in FIG. 5A, however, is the same as a conventional user registration screen other than presence of a link 41 “Use registration code”. When a manager at the customer 30 associates the customer 30 and the MFP 32 with each other in a conventional manner, therefore, the manager may register a mail address (i.e., a manager ID) and a password to the device management server 20 in advance and input the mail address and the password on the screen illustrated in FIG. 5A.

If the deliver person selects the link 41, the registration code reception unit 321 of the MFP 32 displays a screen illustrated in FIG. 5B on the operation panel. When the delivery person inputs a registration code of which the delivery person has been notified in 5103 to an input area 42 and selects an OK button 43, the registration code reception unit 321 receives the input registration code (S302). The information registration processing unit 322 then transmits, to the device management server 20, a request to check a place of installation including the registration code received by the registration code reception unit 321 (S303).

The association unit 24 of the device management server 20 is waiting for data transmitted from the MFP 32. Upon receiving the request to check a place of installation from the MFP 32, the association unit 24 refers to the registration code information registered in the master database 25 and compares the registration code included in the request to check a place of installation with the registration code set in the registration code information. The association unit 24 may also check whether a time at which the request to check a place of installation has been received is within the valid period set in the registration code information. If it is found as a result of the comparison that the received registration code is set in the registration code information and the time at which the request to check a place of installation has been received is within the valid period, the association unit 24 reads the company name set in the registration code information including the registration code and transmits the company name to the MFP 32 (S205).

FIG. 5C is a diagram illustrating an example of a screen for displaying the company name transmitted from the device management server 20. The delivery person selects an OK button 44 after referring to the screen on the operation panel illustrated in FIG. 5C and confirming that the MFP 32 has been installed for the correct customer 30. If the displayed company name is different from the place of installation, the input registration code might be incorrect. The delivery person, therefore, selects a cancel button 45 to display the screen illustrated in FIG. 5B again and inputs a registration code again.

It is assumed here that the correct company name is displayed. In response to the selection of the OK button 44, the information registration processing unit 322 then requests to register information by transmitting the registration code received by the registration code reception unit 321 while attaching the device ID of the MFP 32 to the registration code (S305).

Upon receiving the request to register information including the registration code and the device ID transmitted from the MFP 32, the association unit 24 refers to the registration code information registered in the master database 25 and compares the received registration code with the registration code set in the registration code information. If the association unit 24 has not checked the valid period at a time of the reception of the request to check a place of installation, the association unit 24 also checks whether a time at which the request to register information has been received is within the valid period set in the registration code information. If it is found as a result of the comparison that the same registration code as the received one is set in the registration code information and the time at which the request to register information has been received is within the valid period, the association unit 24 sets and registers the company name set in the registration code information including the registration code to the device information in the master database 25 while associating the device ID received along with the registration code with the company name (S206).

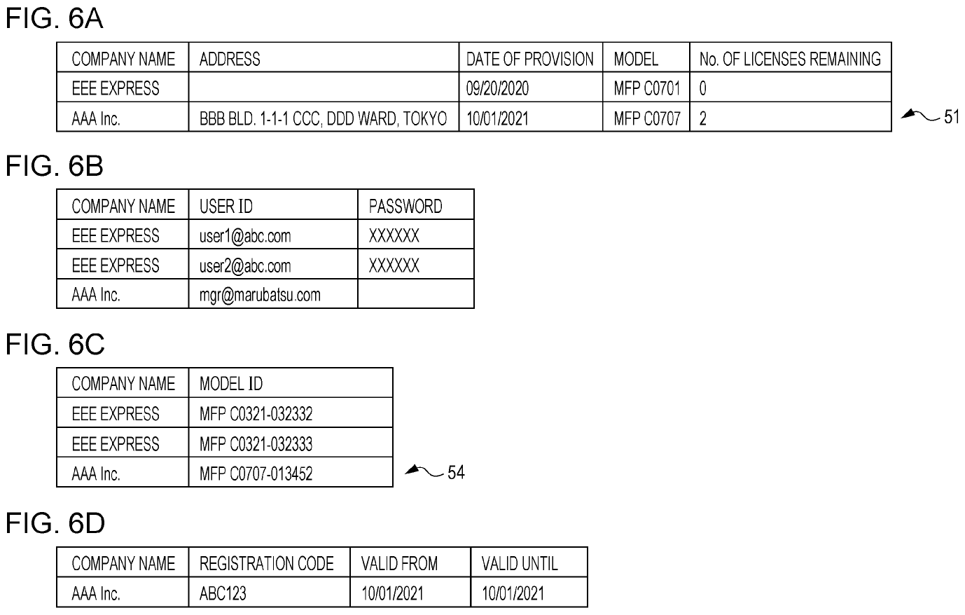

FIGS. 6A to 6D illustrate an example of data settings in the master database 25 after the setting and registration. As indicated by a record 54 illustrated in FIG. 6C, the customer 30 and the MFP 32 are associated with each other in the device information, and the MFP 32 becomes available to the customer 30.

After finishing associating the customer 30 and the MFP 32 with each other in the master database 25 as described above, the association unit 24 notifies the MFP 32 of the completion of the registration of information (S207).

FIG. 5D is a diagram illustrating an example of a screen displayed in accordance with the notification of the completion of the registration of information transmitted from the device management server 20. Upon receiving the notification of the completion of the registration of information from the device management server 20, the information registration processing unit 322 displays the screen illustrated in FIG. 5D on the operation panel. The delivery person refers to the screen on the operation panel illustrated in FIG. 5D and confirms the completion of the process for registering information, which is performed to associate the customer 30 and the MFP 32 with each other.

The setup of the MFP 32 is completed by selecting a close button 46, and the user at the customer 30 can use the MFP 32.

In the above description, one MFP 32 becomes available, and as indicated by a record 51 illustrated in FIG. 6A, the number of licenses remaining decreases by 1 in the company management information. When the delivery person installs the other two MFPs 32 and finishes associating the customer 30 and the MFPs 32 with each other by inputting the registration code to the MFPs 32, the number of licenses remaining becomes 0 in the record 51.

According to the present exemplary embodiment, the delivery person who has delivered the MFPs 32 to the facility of the customer 30 can register the customer 30 and the MFPs 32 while associating the customer 30 and the MFPs 32 with each other by inputting, to the installed MFPs 32, the registration code issued by the device management server 20. The customer 30, therefore, can use the MFPs 32 without performing any operation.

Alternatively, if desired, the customer 30 may be notified of the registration code and input the registration code instead of the delivery person. In this case, too, the customer 30 need not register authentication information for initial settings in advance. Alternatively, the managers at the customer 30 may select a conventional process for registering information using authentication information on the screen illustrated in FIG. 5A. In this case, the screen displayed on the operation panel changes from that illustrated in FIG. 5A to that illustrated in FIG. 5D.

In some cases, the delivery person might simultaneously carry MFPs 32 to be delivered to different customers 30. For example, the delivery person might combine together morning and afternoon deliveries on a truck. The registration code issuance unit 23 of the device management server 20 issues a registration code in units of sales information and does not define any particular rules for generating a registration code. For example, the registration code issuance unit 23 of the device management server 20 does not generate a registration code in accordance with information that depends on a customer, such as a company name. When the delivery person handles plural MFPs 32 and plural registration codes simultaneously, therefore, the delivery person might incorrectly associate the MFPs 32 and customers 30 with each other. More specifically, the delivery person might input, to an MFP 32 installed at a place of installation identified from sales information that is being referred to, an incorrect registration code, that is, a registration code different from one included in the sales information, especially a registration code associated with another place of installation. The delivery person can indeed check the customer 30 for which the MFP 32 is to be installed in the present exemplary embodiment since the screen illustrated in FIG. 5C is displayed on the operation panel. The delivery person, however, might overlook or misunderstand the information.

In the present exemplary embodiment, therefore, a character string that depends on a name of a customer, especially a name of a company to which an MFP 32 is to be delivered, such as a company name or a combination of a company name and a floor of installation, can be associated with sales information as a nickname. As a fact that the character string that depends on the name of the customer is called “nickname” suggests, the salesperson sets, as a nickname, a character string with which a place of installation of an MFP 32 can be easily guessed. FIG. 3C illustrates an example of the nickname.

When the salesperson sets a nickname, sales information transmitted from the core system 10 to the device management server 20 includes the nickname. As with the registration code, the nickname is held and managed by the master database 25 and transmitted to the delivery person. Not the salesperson but the delivery person may attach a nickname to sales information received from the device management server 20 before delivering an MFP 32. In this case, the device management server 20 needs to be notified of the nickname set by the delivery person.

When a nickname is used, the delivery person inputs, to the input area 42 for a registration code, a combination of the nickname and a registration code, such as “marubatsuABC123”. That is, since the delivery person needs to input a character string (i.e., a nickname) with which a customer 30 for which an MFP 32 has been installed, the delivery person can associate the MFP 32 with a correct company name compared to when only a registration code is input.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
generate, in a case where a device with which the information processing apparatus does not begin to communicate is to be installed in a user's facility, a registration code to be used to register information regarding the device;
notify an installation person of installation information regarding installation of the device while attaching the registration code to the installation information, the installation information including at least user identification information for identifying the user; and
register, if a registration code that has been input by the installation person using the device installed in the user's facility and that has been transmitted along with identification information regarding the device matches the registration code generated for the device, the identification information regarding the device and the user identification information for identifying the user to a memory for managing devices while associating the identification information regarding the device and the user identification information for identifying the user with each other.

2. The information processing apparatus according to claim 1,
wherein the installation information includes user identification information with which a user at a place of installation of the device is identifiable.

3. The information processing apparatus according to claim 1,
wherein the installation information includes time information for identifying a valid period of the registration code.

4. A non-transitory computer readable medium storing a program causing a computer to execute a process comprising:
generating, in a case where a device with which the computer does not begin to communicate is to be installed in a user's facility, a registration code to be used to register information regarding the device;
notifying an installation person of installation information regarding installation of the device while attaching the registration code to the installation information, the installation information including at least user identification information for identifying the user; and
registering, if a registration code that has been input by the installation person using the device installed in the user's facility and that has been transmitted along with identification information regarding the device matches the registration code generated for the device, the identification information regarding the device and the user identification information for identifying the user to a memory for managing devices while associating the identification information regarding the device and the user identification information for identifying the user with each other.

5. An information processing method comprising:
generating, in a case where a device with which communication does not begin is to be installed in a user's facility, a registration code to be used to register information regarding the device;
notifying an installation person of installation information regarding installation of the device while attaching the registration code to the installation information, the installation information including at least user identification information for identifying the user; and
registering, if a registration code that has been input by the installation person using the device installed in the user's facility and that has been transmitted along with identification information regarding the device matches the registration code generated for the device, the identification information regarding the device and the user identification information for identifying the user to a memory for managing devices while associating the identification information regarding the device and the user identification information for identifying the user with each other.
